(19) United States
(12) Patent Application Publication
(10) Pub. No.: US 2025/0339929 A1
(43) Pub. Date: Nov. 6, 2025

(54) STEADY REST WITH PREDICTABLE MICRON-SIZED ADJUSTMENT

(71) Applicant: Arobotech Systems, Inc., Madison Heights, MI (US)

(72) Inventors: Richard John LESSWAY, Bloomfield Hills, MI (US); Shawn Elizabeth Schultz, Fenton, MI (US); Anthony DEAN, Madison Heights, MI (US)

(21) Appl. No.: 19/272,091

(22) Filed: Jul. 17, 2025

Related U.S. Application Data
(63) Continuation-in-part of application No. 17/981,161, filed on Nov. 4, 2022, now Pat. No. 12,383,998.
Application No. 17/981,161 is a continuation-in-part of application No. 17/680,891, filed on Feb. 25, 2022, now Pat. No. 12,350,785.

(51) Int. Cl. B23Q 7/04; B23P 6/00; B23P 23/04

(52) U.S. Cl. CPC B23Q 7/047; B23P 6/00; B23P 23/04; B23Q 7/046

(57) ABSTRACT

A steady rest has working and right-hand cover plates and a central plate sandwiched between them. The working cover plate has upper and lower open jaw-shaped guide tracks that are received within cavities. The central plate is movably disposed between the working and right-hand cover plates. The central plate slidably engages upper and lower gripping arms that are movable relative to the working cover plate between a clamped position and a retracted position. Tapered rails and rail engagement springs are disposed in a rail recess of the working cover plate. The rails are movable relative to each other to finely and precisely adjust the position at which the workpiece is clamped and moved horizontally or vertically when the gripping arms are in the clamped position.

### CROSS-REFERENCE TO RELATED APPLICATION

This application is a continuation-in-part of U.S. Ser. No. 17/981,161 filed Nov. 4, 2022, which is a continuation-in-part of U.S. Ser. No. 17/680,891 filed Feb. 25, 2022, now U.S. Pat. No. 12,350,785 issuing Jul. 8, 2025, all of which are incorporated by reference herein in their entirety.

### TECHNICAL FIELD

The present disclosure relates to a finely adjustable steady rest system with a simplified design for positioning a rotationally symmetrical workpiece.

### BACKGROUND

An adjustable steady rest system is commonly used for securing a workpiece during machining operations, such as but not limited to grinding, turning, milling, and boring. In such systems, gripping arms secure the workpiece, while a cutting tool, such as an abrasive wheel, blade, or bit, removes material from it. Known steady rests have a mechanism for adjusting the position or location of the gripping arms, thereby enhancing the accuracy of machining operations.

Today's machines often demand high tolerances. Such challenges are often presented in high production volumes. Desirably, adverse workpiece conditions such as out-of-roundness and lobing should be avoided.

End users expect adjustment mechanisms to be accurate, capable of fine adjustment, repeatable, and reliable. Reducing the number of parts, particularly the number of moving parts, is advantageous. This may increase the reliability of the mechanism and reduce the likelihood of moving parts coming into contact with contaminants. Furthermore, reducing the number of parts may reduce tool manufacturing costs and complexity.

Against this background, it would be desirable to offer a refined adjustment system that enables a higher precision in repeatable adjustment with a minimal number of parts required to bring about such an adjustment.

Ideally, such a system would be designed to facilitate repairing with minimal downtime.

Such adjustment mechanisms have a number of parts that should ideally cooperate so that none of them stick or unnecessarily interfere with each other when guided movement is called for in the adjustment process. It would be desirable to anticipate the potential for such unwanted interference by providing ameliorating design changes. For example, it would be desirable to eliminate any potential for a spring to become “pinched” between adjacent parts of the adjustment mechanism. Another example relates to situations where a part receives another moving part. Ideally, the interface between the two parts should be contoured so that there is no unwanted binding interference. Such factors assume importance when the two parts cooperate under the influence of high-engagement forces.

To facilitate replacement and repair, it would be helpful to reduce the number of springs, yet have all springs in an adjustment mechanism with the same dimensions and share common mechanical properties to be readily interchangeable.

Ideally, the springs should not be subjected to unnecessary compression in a single or repeated use, as such exposure may cause the spring to lose at least some of its rebounding properties.

Thus, it would be desirable to have a mechanism that permits a more precise adjustment system, accommodating design criteria such as those described above.

Among the references considered in preparing this application are U.S. Pat. Nos. 9,174,317 and 8,955,419. Those references are incorporated here by reference, to the extent that they are not inconsistent with the disclosure herein.

### SUMMARY

Several embodiments of the disclosed steady rest adjustment mechanisms comprise a number of parts that cooperate to prevent any of them from sticking or unnecessarily interfering with each other when guided movement is required during the adjustment process. In such embodiments, any potential for a spring to become “pinched” between adjacent parts of the adjustment mechanism is eliminated.

The present disclosure also addresses situations where a part comes into contact with another moving part. So that there is no unwanted binding interference therebetween, mating surfaces that define the interface between the two parts are contoured. Such factors assume importance when the two parts cooperate under the influence of high-engagement forces.

In one embodiment, the present disclosure provides a steady rest system for precisely locating a workpiece that is rotated and subjected to forces exerted by one or more machine tools in a direction inclined (e.g., orthogonal) to an axis of workpiece rotation. One steady rest has a working cover plate (as further described below) and a right-hand cover plate (when viewed from the rear). Between these plates is a central plate (which moves in parallel with an X- or horizontal axis). The working cover plate has a pair of T-shaped recesses or cavities that receive two improved jaw-shaped guide tracks that define open inner walls, which ultimately influence and enable finely tuned displacement of upper and lower gripping arms that secure and displace a workpiece. The improved guide tracks weigh less than previous embodiments, are less bulky and can be more readily machined. More precise manufacturing processes can be enabled.

Within the guide tracks, roller guides of alternative shapes move in a defined, precise, and predictable manner along open inner walls defined between the jaw-shaped guide tracks.

The central plate slidably engages the upper and lower gripping arms. The gripping arms are movable between a closed, clamped position and an open, retracted position to releasably secure the workpiece. In the closed clamped position, the workpiece can be minutely re-positioned horizontally and vertically.

Fine, predictable, and precise horizontal and vertical adjustments of the gripped workpiece are enabled.

### BRIEF DESCRIPTION OF THE DRAWINGS

The drawings described herein are for illustrative purposes of selected embodiments and not all possible implementations. They are not intended to limit the scope of the present disclosure.

FIG. 1 is a perspective, exploded view of part of a simplified adjustable steady rest system with a right-hand cover plate removed for clarity;

FIG. 2 is a laid-open, exploded view of the steady rest system that depicts improved jaw-shaped guide tracks;

FIG. 3A is a vertical, sectional view of the steady rest system along the line B-B in FIG. 3B;

FIG. 3B is a vertical, sectional view of the steady rest system;

FIGS. 4A and 4B illustrate various components and improved guide tracks in vertical adjustment modes without track engagement springs;

FIGS. 5A and 5B illustrate various components and improved guide tracks in horizontal adjustment modes without track engagement springs;

FIG. 6 further illustrates horizontal displacement of a clamped workpiece in response to turning an adjustment screw;

FIG. 7 further illustrates vertical displacement of a clamped workpiece in response to turning another adjustment screw;

FIG. 8A and FIG. 8B are earlier steady rest embodiments.

FIG. 8C is an earlier steady rest design. FIG. 8D is its revision, which dispenses with track engagement springs and has improved jaw-shaped upper and lower guide tracks; and

FIGS. 8E and 8F illustrate alternative embodiments of bushings for facilitating the manufacture of a steady rest system.

Corresponding reference numerals indicate corresponding parts throughout the several drawings.

### DETAILED DESCRIPTION

Representative embodiments and enhancements to earlier steady rests will now be described more fully with reference to the accompanying drawings.

### Components of a Representative Steady Rest System

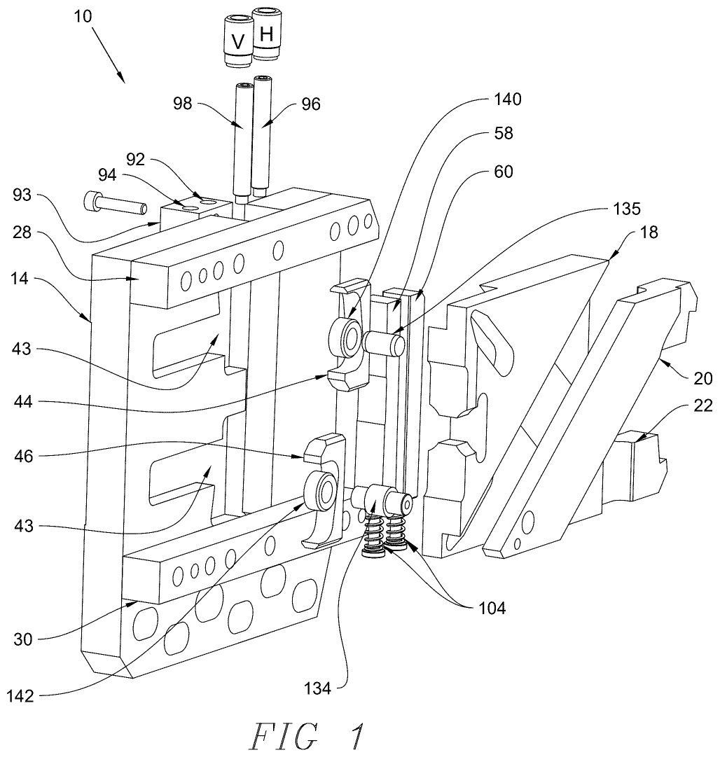

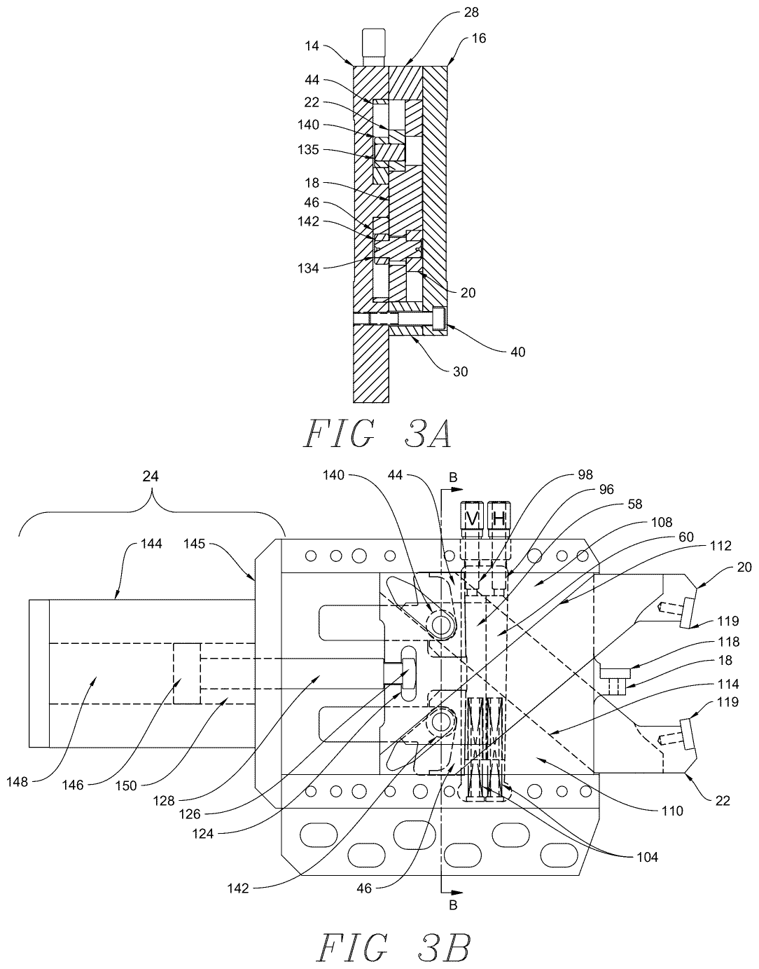

With reference to FIGS. 1-FIG. 8F, in one embodiment, a simplified adjustable steady rest system (hereinafter “steady rest”) 10 is provided that is adapted to clamp and if desired, finely adjust the position of a workpiece during a machining operation (e.g., grinding or turning) by horizontal or vertical displacement or both horizontal and vertical displacement. In one embodiment, the steady rest 10 preferably includes a working cover plate 14 with T-shaped cavities 43 (to be discussed in more detail below), a right-hand cover plate 16 (as viewed from FIG. 3A), and a central plate 18 that is slidably positioned between them.

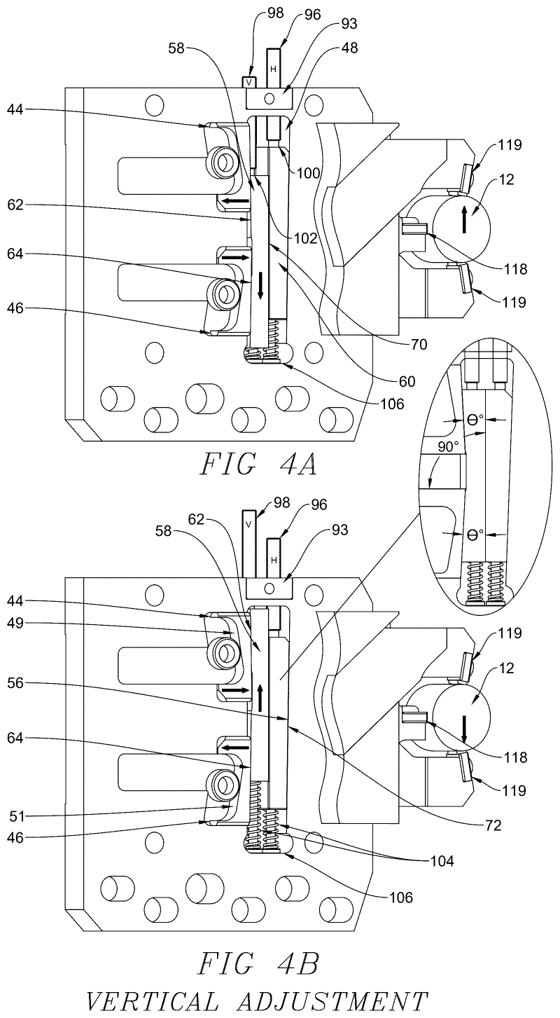

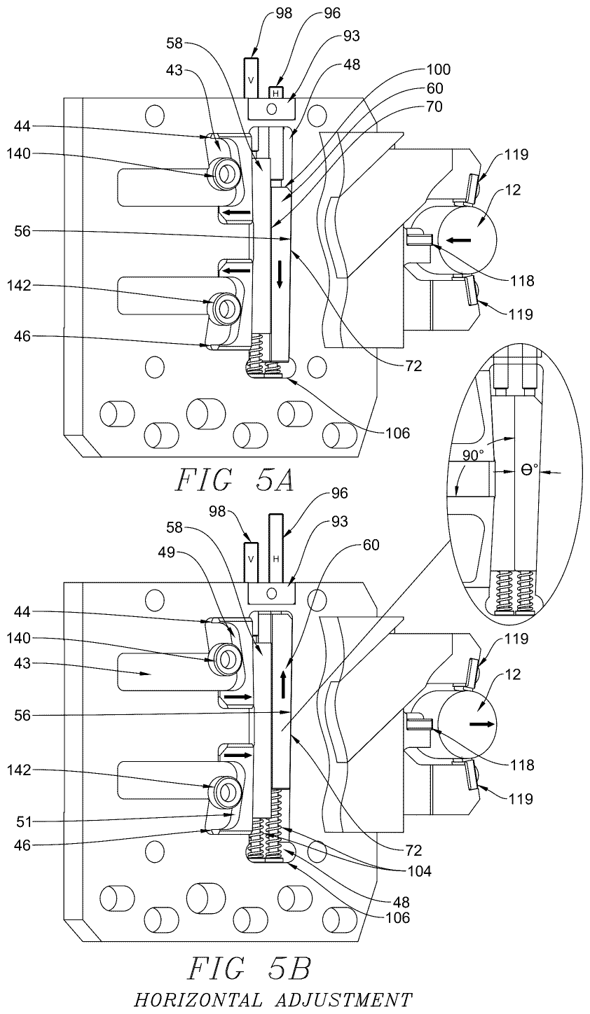

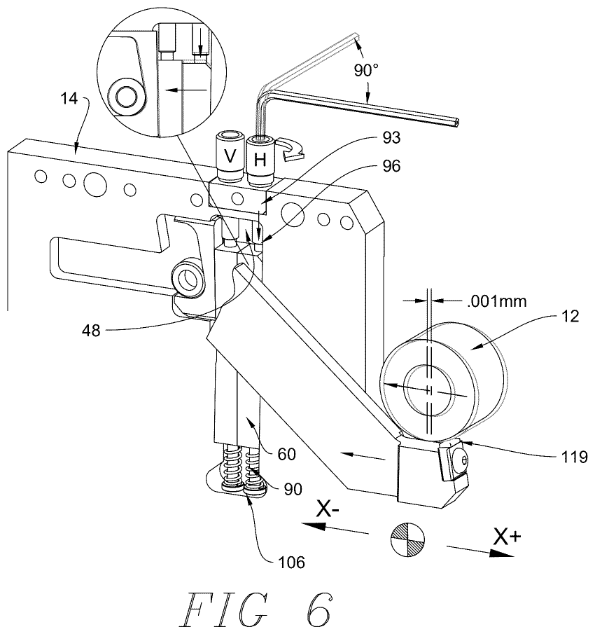

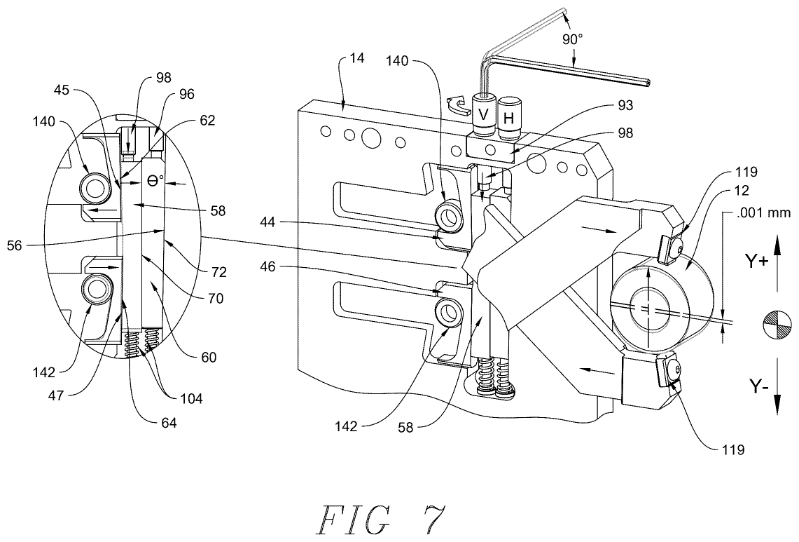

The steady rest 10 is adapted to cause gripping and displacement of the workpiece 12 vertically (FIGS. 4A, 4B and 7), or horizontally (FIGS. 5A, 5B and 6).

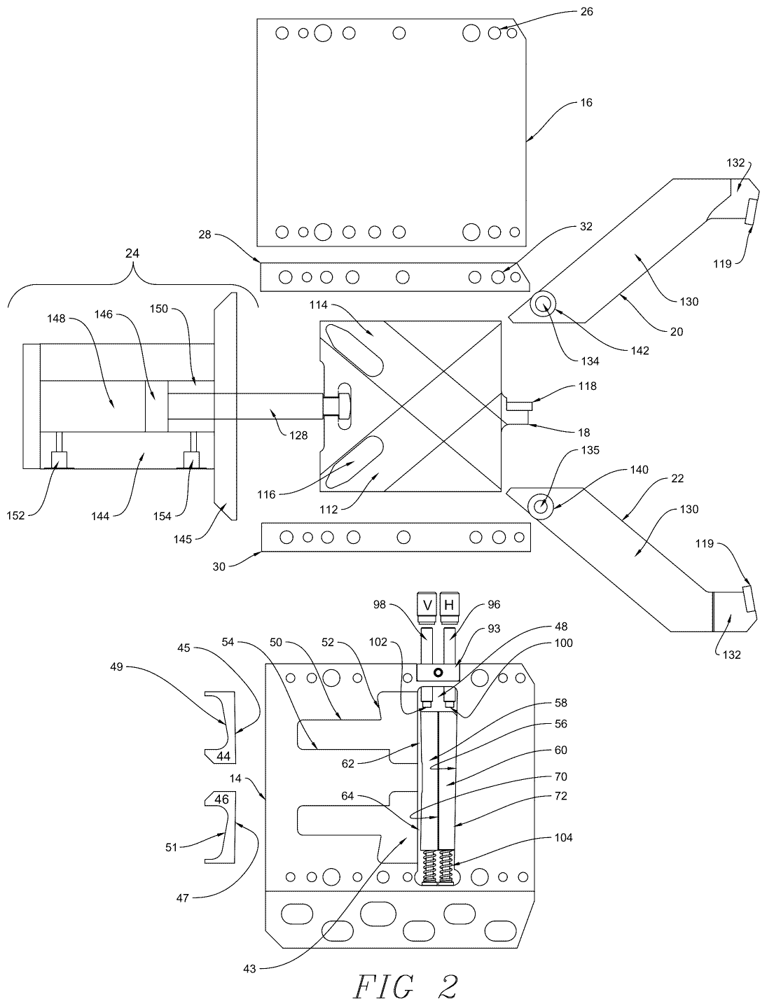

Upper and lower gripping arms 20, 22 (FIG. 1) and a cylinder/piston actuation mechanism 24 (FIG. 2) are provided. As will be described in more detail below, the actuation mechanism 24 is operable to move the central plate 18 and the gripping arms 20, 22 between a clamped position, in which the steady rest 10 grips the workpiece 12, and a retracted position, in which the workpiece 12 is released and the gripping arms 20, 22 are retracted into the steady rest 10.

As depicted in FIG. 2, the working cover plate 14 is a generally solid, flat plate having a plurality of threaded and unthreaded mounting apertures 32 (FIG. 2). Upper and lower slide plates 28, 30 (FIG. 1) are mounted (directly or indirectly) to the working cover plate 14. The central plate 18 is adapted to move between and be guided by the slide plates 28 and 30. The upper and lower slide plates 28, 30 include threaded and/or unthreaded apertures 32 aligned with the apertures 26 in the working cover plate 14.

The right-hand cover plate 16 (FIG. 3A) has apertures aligned with the apertures 32 of slide plates 28 and 30 and with the apertures 26 of the working cover plate 14. Bolts 40 or other fasteners are received in some or all of the apertures to secure the working and right-hand cover plates 14 fixedly, and 16 to each other and to slide plates 28 and 30 The central plate 18 is sandwiched therebetween (as shown in FIGS. 1 and 3). It is movable horizontally between the slide plates 28,30.

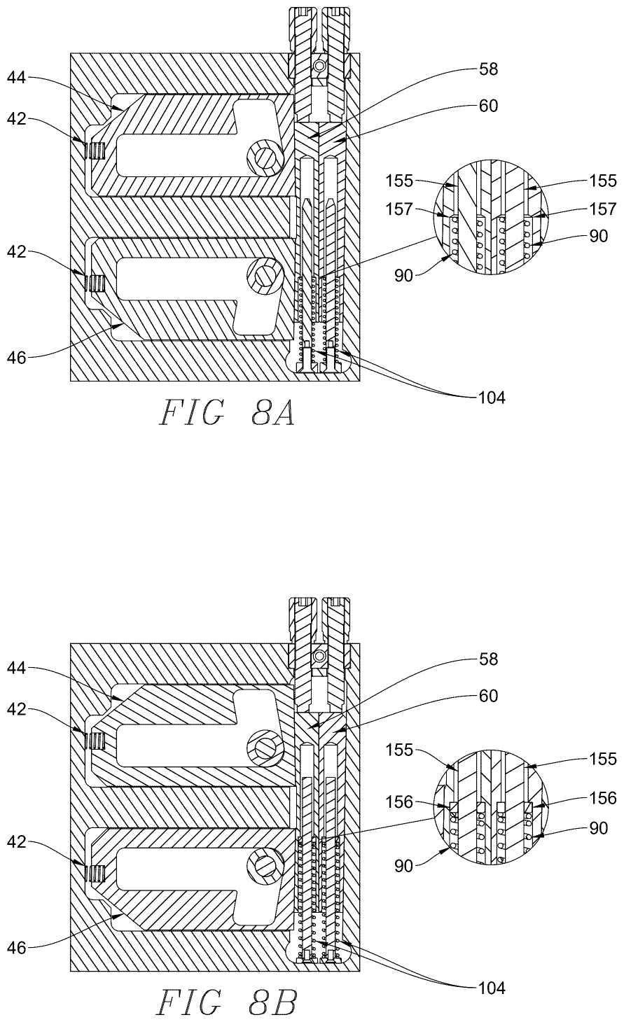

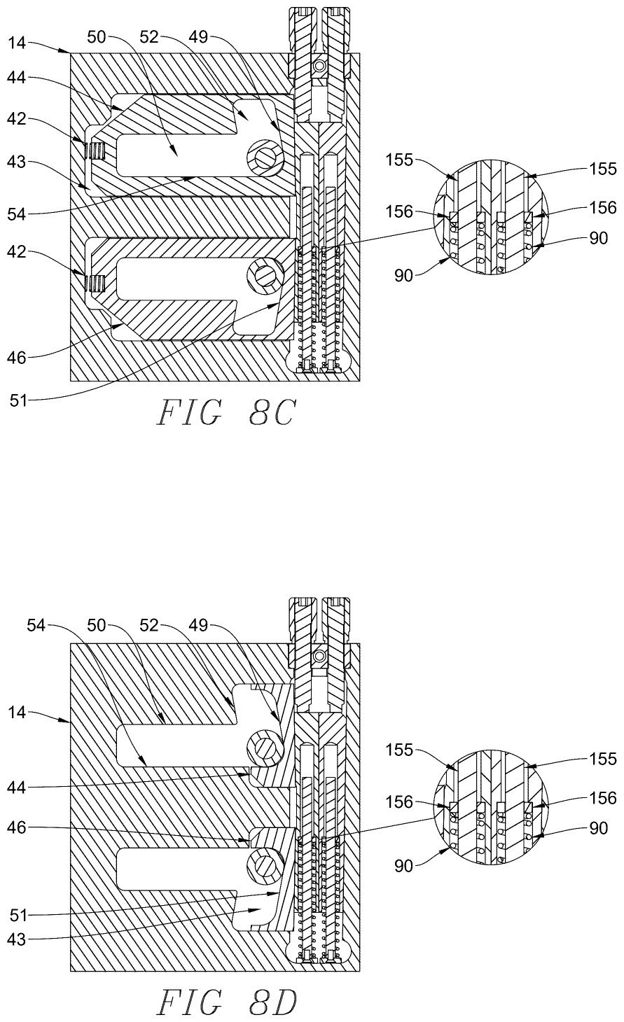

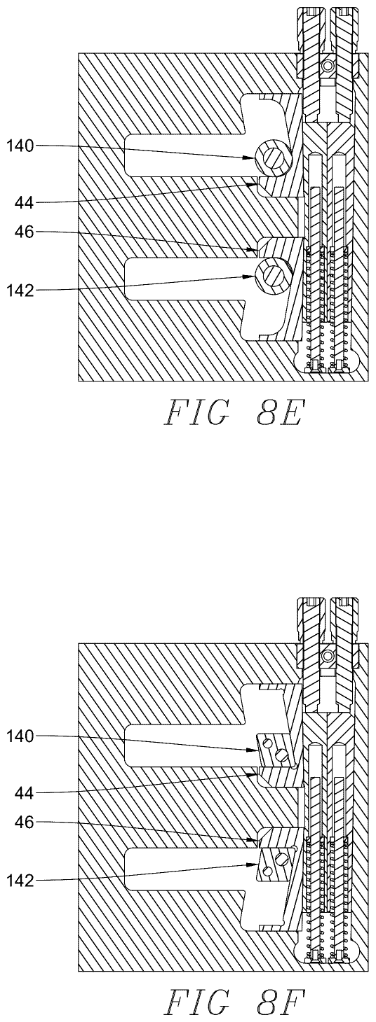

The working and right-hand cover plates 14, 16, and slide plates 28, 30 cooperate to define T-shaped cavities 43 in which simplified jaw-shaped guide tracks 44 and 46 are fixedly received. In an earlier design, the guide tracks 44, 46 are adapted to move horizontally. In the present design, track engagement springs 42 (FIGS. 8A, 8B, and 8C) are no longer needed. This removes an additional setup step and tooling change in the manufacturing process. Formerly, track engagement springs 42 were selected to withstand repeated compression and rebound. As a result of modified cavities 43 and simplified stationary guide tracks 44 and 46, the mean time to repair has been shortened, and maintenance costs have been reduced. Less material needs to be removed during the manufacturing of the working cover plate 14. This helps maintain critical flatness tolerances. Additionally, it allows more area to remain in the working cover plate 14, thereby enabling custom alterations to be made.

Previously, an inner wall, 49, 51, of each guide track, 44, 46, was closed. See e.g., FIGS. 8A, 8B, and 8C. The modified design calls for reconfigured guide tracks 44 and 46. Under the simplified design, each guide track has an inner wall 49, 51 that is open and jaw-shaped. See e.g., FIGS. 4A-7. In use, the inner wall 49, 51 guides and ultimately constrains the movement of the bushings 140, which in turn influence the displacement of the gripping arms 20, 22.

As shown in FIGS. 1-2, the working cover plate 14 accommodates the upper and lower guide tracks 44, 46 that are received in the cavities 43 (FIG. 1). Each of the guide tracks 44, 46 preferably includes an elongated leg 50 and a relatively shorter leg 52 (FIG. 2). The legs 50 of the upper and lower guide tracks 44, 46 preferably extend parallel to each other and parallel to a longitudinal axis-X (FIG. 6). Each of the shorter legs 52 extends from an end of a corresponding one of the longer legs 50 in a direction that is laterally outward and away from the workpiece 12 (i.e., an acute angle is formed between the longer and shorter legs 50, 52).

To displace the gripping arms 20, 22 and thus a clamped workpiece 12 in precise, predictable and finely metered amounts, several components cooperate to displace a workpiece vertically (FIGS. 4A, 4B, and 7) and horizontally (FIGS. 5A, 5B, and 6).

Shaped rails 58, 60 (FIG. 1) respectively cooperate to finely displace a workpiece 12 vertically and horizontally with predictable precision in a manner to be described. These rails are slidingly movable within a rail recess 48 independently of each other (e.g., FIGS. 2-7). The vertical rail 58 has a flat face 70 (enlargement, FIG. 7) that abuts the horizontal rail 60 and an opposing face with inclined sections 62 64 that meet on opposing sides of a flat middle section.

The working cover plate 14 has threaded apertures 92, 94 (FIG. 1) that extend preferably perpendicularly to the longitudinal axis X-X and communicate with the rail recess 48 (FIG. 2). Adjustment screws or rods 96, 98 (FIGS. 2, 6-7) threadedly engage the threaded apertures 92, 94, respectively, and extend into the rail recess 48. Ideally, approximately 100 threads per inch are provided to enable finely tuned adjustments to be made. An end 102 of the upper or vertical adjustment rod 98 abuts an end of the rail 58, which ultimately adjusts the workpiece position minutely vertically (“vertical rail 58”). An end 100 of the lower or horizontal adjustment rod 96 abuts an end of the rail 60 (FIG. 5A), which ultimately finely tunes the workpiece position minutely horizontally (“horizontal rail” 60).

Rail engagement springs 104 (FIG. 2) are positioned between a lower wall 106 of the rail recess 48 and a corresponding one of the vertical and horizontal rails 58, 60 (FIGS. 4A, 4B, 5A, and 5B). Preferably, all engagement springs share common mechanical characteristics to facilitate maintenance and interchangeability. Common characteristics eliminate inventory problems associated with stocking differently sized springs.

Rail engagement springs 104 (FIG. 4B) bias the rails 58, 60 into contact with the axial ends 100, 102 of the adjustment rods 96, 98. In this manner, the rails 58, 60 move toward and away from the lower wall 106 (in the directions shown in FIGS. 4-5) as the adjustment rods 96, 98 are moved along the threaded apertures 92, 94 into and out of the rail recess 48.

Threadedly adjusting the position of the horizontal adjustment rod 96 (FIGS. 5A, 5B, and 6) causes the horizontal rail 60 to slide in relation to a wall of the rail recess 48. There is a relative angle (theta) between the wall and side 72 of the horizontal rail 60 (FIG. 5A and enlargement, FIG. 5B). Thus, a wedge-like effect is created in which movement of the horizontal rail 60 along wall 56 causes corresponding movement of the vertical rail 58 toward or away from the wall 56 in a direction along or parallel to the longitudinal X-axis.

Threadedly adjusting the position of the vertical adjustment rod 98 (FIGS. 4A, 4B and 7) causes the vertical rail 58 to slide in relation to the wall 70 of the horizontal rail 60. There is a relative angle (theta) between the walls 62, 64 of the vertical rail 58 and walls 45, 47 of the guide tracks 44, 46 (enlargement, FIG. 4B). Thus, movement of the vertical rail 58 along the wall 70 causes opposing movement of the guide tracks 44, 46 toward and away from the wall 70 in a direction along or parallel to the vertical Y-axis.

Cross channels 112, 114 (FIGS. 2, 3A, and 3B) formed in the central plate 18 slidingly receive the gripping arms 20, 22. The upper channel 112 receives the upper arm 20. The lower channel 114 receives the lower arm 22. A slot 116 extends into the upper channel 112. A longitudinal axis of the slot 116 extends parallel to a longitudinal axis of the upper channel 112. Similarly, for a slot provided in the lower channel 114. The upper and lower channels 112, 114 are angled relative to the longitudinal axes and to each other. The upper and lower channels 112, 114 cross each other to form a generally X-shaped pattern. Channels 112 and 114 are configured so that the upper and lower gripping arms 20 and 22 can move without interfering with each other.

A gripping finger 118 extends from the central plate 18 between the upper and lower channels 112, 114 (FIG. 3B). The gripping finger 118 cooperates with gripping fingers 119 of the upper and lower gripping arms 20, 22 to grip and finely displace the workpiece 12 when the steady rest 10 is in the clamped position (FIGS. 4-7).

Another end of the central plate 18 has a generally T-shaped aperture 124. As shown in FIG. 3B, the T-shaped aperture 124 receives a similarly shaped end 126 of a ramrod 128 of the actuation mechanism 24.

Each of the upper and lower gripping arms 20, 22 is preferably provided with an elongated upper portion 130 and a relatively shorter lower portion 132 (FIG. 2). The upper and lower portions 130, 132 are preferably angled relative to each other. The gripping fingers 119 extend toward each other from the lower portions 130, 132.

The upper portions 130 of the gripping arms 20, 22 (FIG. 2) include pins or roller guides 134, 135 (FIGS. 1, 2) that protrude therefrom and extend into and have their movement constrained by a corresponding one of the upper and lower jaw-shaped guide tracks 44, 46. As shown in FIG. 2, pin 134 of the upper gripping arm 20 extends through slot 116 and into the lower guide track 46. In this way, the axial end of the pin 134 slidably engages the groove 54 of the lower guide track 46. Pin 135 of the lower gripping arm 22 extends into the upper guide track 44. The axial end of pin 135 slidably engages the groove 54 of the upper guide track 44. The pins 134, 135 have bushings 140, 142 that are slidably received in the lower and upper guide tracks 46, 44, respectively (FIG. 3B). Alternative embodiments of the bushings 140, 142 have different shapes (see, FIGS. 8E, 8F), discussed below.

Turning now to FIGS. 2 and 3B, the actuation mechanism 24 includes a housing 144 with a chamber 148, a piston 146, and a ramrod 128. The housing 144 has a flange 145 that is bolted or otherwise mounted to the working cover plate 14 and/or the right-hand cover plate 16. The housing 144 and the piston 146 define fluid chambers 148, 150 in communication with upper and lower ports 152, 154, respectively (FIG. 2). The piston 146 is attached to the ramrod 128 and separates the fluid chambers 148, 150. Ports 152, 154 are in fluid communication with a source of working fluid (e.g., compressed air or preferably, hydraulic fluid). A fluid control device (not shown) is operable to control the flow of the working fluid in and out of ports 152, 154 (FIG. 2).

To move the piston 146 and ramrod 128 away from the workpiece 12, the control device causes working fluid to flow into the fluid chamber 150 while evacuating fluid from the other fluid chamber 148. To move the piston 146 and ramrod 128 toward the workpiece 12, the control device causes working fluid to flow into fluid chamber 148 while evacuating fluid from the chamber 150. Because the ramrod 128 is connected to the central plate 18, movement of the piston 146 and ramrod 128 toward and away from the workpiece 12 causes corresponding movement of the central plate 18 toward and away from the workpiece 12.

While the actuation mechanism 24 is described above as being a fluid-actuated device, it will be appreciated that any type of actuator could be used (e.g., an electric motor or another electromechanical device). Preferably, the fluid is a liquid.

As described herein, the vertical threaded adjustment rod 98 lies on the left side (from the perspective of FIG. 1). In alternative embodiments, the vertical threaded adjustment rod 98 and related components may lie on the right side.

In conventional steady rests, threaded (tapped) holes are provided directly into the working and right-hand cover plates 14, 16. If the threads become damaged, the cover plates themselves often need to be replaced. Such an operation involves downtime and related costs. But with the steady rests systems disclosed herein, most repairs (if needed) are limited to replacement of the horizontal and/or threaded adjustment rods 96, 98, that are threadedly received within the slidingly removable brass block 93 (FIGS. 1, 2, 4A, 4B, 5A, 5B, 6, 7). Such steps are economically advantageous in comparison to prior approaches.

### Operation of a Representative Steady Rest System

### (a) Clamping and Releasing the Workpiece

With continued reference to FIGS. 1-8F, the operation of a representative embodiment of a steady rest system 10 will now be discussed. As described above, the actuation mechanism 24 (FIG. 2) is adapted to move the central plate 18 and the gripping arms 20, 22 between a clamped position, in which the steady rest 10 grips the workpiece 12, and a retracted position, in which the workpiece 12 is released and the gripping arms 20, 22 are retracted into the steady rest 10.

The steady rest 10 can be finely, precisely, and predictably adjusted to move the position of the workpiece 12 relative to the steady rest 10 when the workpiece 12 is in the clamped position (see FIGS. 4-7). For example, a 90-degree turn of a vertical or horizontal adjustment rod 96, 98 can displace a gripped workpiece by 1 micron while holding the workpiece 12 in place, despite forces exerted by machining operations and by the spinning mass of the workpiece. Such precision was not possible in conventional steady rests.

To move the steady rest 10 from the retracted position to the clamped position, working fluid is injected into chamber 148 of the actuation mechanism 24, and working fluid (if present) is evacuated from chamber 150 (FIG. 2). This causes the piston 146 and the ramrod 128 to move toward the workpiece 12 (i.e., to the right relative to the frame of reference of FIG. 3B).

The central plate 18 moves with the ramrod 128 along the longitudinal X-axis relative to the working plate 14 and the right-hand plate 16 (FIG. 3A). As the central plate 18 and gripping arms 20, 22 move toward the clamped position, the pins 134, 135 and bushings 140, 142 slide along the legs 50 of the corresponding guide tracks 44, 46 (FIG. 3B). Continued movement of the ramrod 128 and central plate 18 along the longitudinal X-axis toward the workpiece 12 causes the bushings 140, 142 to come into contact with the inner walls of the open jaw surfaces 49, 51 respectively, of the guide tracks 44, 46 (FIG. 5B).

Preferably, the rails 58, 60 engage each other under the influence of a sliding interference fit. In one embodiment, there is about a 1-degree inclination of face 64 and surface 47 and face 62 and surface 45 (enlargement, FIG. 7). Correspondingly, there is about a 1-degree inclination between face 56 and surface 72.

Once the bushings 142, 140 are in contact with the guide tracks 44, 46 and thus the surfaces 62, 64 (FIGS. 4A and 7) of the vertical rail 58, continued movement of the ramrod 128 and central plate 18 along the longitudinal X-axis toward the workpiece 12 causes the pins 134, 135 (FIGS. 1, 2) and bushings 140, 142 to slide laterally outwardly along the lower legs 52 of the guide tracks 44, 46. As the roller guides 134, 135 and bushings 140, 142 slide laterally outwardly along the lower legs 52 of the guide tracks 44, 46, the protruding ends (i.e., the lower portions 132) of the gripping arms 20, 22 move toward each other. The direction of movement of the protruding ends is in a direction perpendicular to the longitudinal X-axis. The gripping arms 20, 22 slide in the channels 112, 114, respectively, relative to the central plate 18 until the gripping fingers 119 of the gripping arms 20, 22 and the gripping finger 118 of the central plate 18 come into contact with and securely clamp the workpiece 12.

To move the steady rest 10 from the clamped position to the retracted position (FIG. 7), working fluid is injected into chamber 150 of the actuation mechanism 24, and working fluid (if present) is evacuated from the other chamber 148. This causes the piston 146, the ramrod 128, and the central plate 18 to move relative to the working and right-hand cover plates 14, 16 away from the workpiece 12 after releasing it. Such movement reverses the movement of the gripping arms 20, 22 described above.

### (b) Displacing the Workpiece Horizontally and Vertically

Turning now to FIGS. 4-7, the adjustment rods (fine screws, with approximately 100 threads per inch) 96, 98 can be turned to finely adjust the position in which the clamped workpiece 12 will be moved by the gripping fingers 118, 119.

As shown in FIG. 6, to move the workpiece 12 horizontally toward the working and right-hand cover plates 14, 16, the user rotates the horizontal adjustment rod 96 in a direction that causes movement of the horizontal rail 60. Such movement occurs within recess 48 in a direction perpendicular to the longitudinal X-axis. Rail engagement springs 90 urge the rails 96, 98 upwardly.

There is a fine angle of inclination (theta, about 0.92 to 1.08 degrees, preferably 1.00 degrees) between the horizontal rail 60 and the wall of recess 48. As a result, a wedge effect is created that influences and constrains the movement of the guide tracks 44, 46 that abut the rail 58.

By moving the horizontal guide rail 60 upwardly under the influence of an associated rail engagement spring 90 (FIGS. 5B, 6), the position along the guide tracks 44, 46 at which the bushings 140, 142 contact the guide tracks 44, 46 also moves outwardly.

FIGS. 6-7 schematically illustrate how the rotation of one or both adjustment screws 96, 98 move a clamped workpiece inwardly or outwardly (FIG. 6) and/or upwardly and downwardly (FIG. 7).

For example, to precisely move the workpiece 12 in a vertical direction, the user rotates the adjustment rod 98 to adjust the position of the gripping fingers 118, 119. In one case, a clockwise displacement of 90 degrees raises the workpiece 12 by 1 micron. Conversely, counterclockwise displacement lowers the workpiece by an equal and corresponding amount.

It will be appreciated that intermediate adjustments may be made, and that displacement is not limited to 90-degree increments or decrements.

The steady rest 10 may hold the workpiece 12 for a grinding operation. It will be appreciated, however, that the principles of the present disclosure may apply to steady rests configured for turning operations and/or other machining or manufacturing operations.

FIGS. 8A-8C depict enhancements to an earlier design. FIG. 8A is the original design and FIG. 8B-8C is its revision. Each has track engagement springs 42 received in associated cavities. These features are absent in the current design. Their absence means fewer parts need to be assembled, and removes a potential failure point as springs wear and degrade over time.

FIG. 8D is an illustrative embodiment of the present disclosure. It depicts an upper guide track 44 and a lower guide track 46. In each of these guide tracks, there are open jaw-shaped inner walls that receive and guide the bushings 140, 142. In FIG. 8E, those bushings are generally circular in cross-section.

FIG. 8F depicts an alternative embodiment in which the bushings 140, 142 have a cross-section that resembles a parallelogram. Ease of manufacture and timing may influence which type of bushing is used.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### REFERENCE LIST

10 Steady rest system
12 Workpiece
14 Working cover plate
16 Right-hand cover plate
18 Central plate
20 Upper gripping arm
22 Lower gripping arm
24 Actuation mechanism
26 Apertures
28 Upper slide plate
30 Lower slide plate
32 Aperture
40 Bolt
42 Track engagement spring-prior art
43 T-shaped cavity
44 Upper guide track with open jaw
45 Side wall of upper track
46 Lower guide track with open jaw
47 Side wall of lower track
48 Rail recess
49 Open inner wall of upper guide track
50 Elongated upper leg
51 Open inner wall of lower guide track
52 Shorter lower leg
54 Groove
56 Upper wall
58 Vertical rail
60 Horizontal rail
62 Upper side of vertical rail
64 Lower side of vertical rail
70 Upper side of horizontal rail
72 Lower side of horizontal rail
90 Rail engagement spring
92 Threaded aperture
93 Slidingly removable block
94 Threaded aperture
96 Horizontal threaded adjustment rod
98 Vertical threaded adjustment rod
100 Axial end of 96
102 Axial end of 98
104 Rail engagement springs
106 Second wall of 48
108 First side of 18
110 Second side of 18
112 Upper cross channel
114 Lower cross channel
116 Slot
118 Gripping finger
119 Gripping finger arm
124 T-shaped aperture
126 T-shaped end of 128
128 Ramrod of 24
130 Elongated first portion of gripping arms
132 Shorter second portion of gripping arms
134 Pin
135 Pin
140 Bushing
142 Bushing
144 Housing
145 Flange
146 Piston
148 First fluid chamber
150 Second fluid chamber
152 Port
154 Port
155 Rail Pin
156 Rail Washer
157 Rail Spring Pocket

What is claimed is:

1. A steady rest for gripping and finely positioning a workpiece, the steady rest comprising:
a working cover plate with a block defining threaded apertures that is slidingly received in the working cover plate and a right-hand cover plate,
a central plate disposed between the working and right-hand cover plates, the central plate being adapted to move slidably therebetween, the central plate having an upper and a lower cross-channel for engaging upper and lower gripping arms, the gripping arms being movable relative to the working and right-hand cover plates between a clamped position and a retracted position, the working cover plate also having a rail recess and a pair of cavities that respectively receive open jaw-shaped upper and lower guide tracks;
a tapered horizontal rail situated in the rail recess, the tapered horizontal rail being adapted to cause displacement of the workpiece horizontally;
a vertical rail with a mating flat face that abuts the horizontal rail and an opposing face with inclined sections that meet on opposing sides of a flat middle section, the vertical rail being adapted to move the workpiece vertically, the vertical rail also being received in the rail recess,
the horizontal and vertical rails contacting the rail recess and each other while controlling location of the gripping arms, the horizontal and vertical rails being movable relative to each other within the rail recess under the influence respectively of a horizontal adjustment rod and a vertical adjustment rod that are received in apertures defined in the block to adjust a position relative to the working and right-hand cover plates at which the workpiece will be clamped when the upper and lower gripping arms are in the clamped position,
wherein a 90 degree turn of the vertical adjustment rod displaces the workpiece vertically by 1 micron, or a 90 degree turn of the horizontal adjustment rod displaces the workpiece horizontally by 1 micron and securely repositions the gripped workpiece while holding the workpiece in place, despite forces exerted by machining operations and by a spinning mass of the workpiece so that the steady rest is configured to support and displace the workpiece predictably before and during machining.

2. The steady rest of claim 1, further comprising horizontal and vertical threaded adjustment rods are threadedly received in apertures of the working cover plate that are defined in the block and extend into the rail recess, the rods and the apertures being provided with 100 threads per inch to facilitate micron-sized fine adjustment, the horizontal threaded adjustment rod abutting the horizontal rail and being rotatable to adjust a position of the horizontal rail, the vertical threaded adjustment rod abutting the vertical rail and being rotatable to adjust a position of the vertical rail.

3. The steady rest of claim 2, further comprising a horizontal rail engagement spring and a vertical rail engagement spring for biasing respectively the horizontal and vertical rails into contact with an upper wall of the rail recess.

4. The steady rest of claim 1, wherein the horizontal rail includes a flat side that slidingly engages the vertical rail and an opposing side that slidingly engages a wall of the rail recess, wherein the flat side and the wall are inclined by an angle theta, where theta lies between 0.92 and 1.08 degrees.

5. The steady rest of claim 1, wherein the upper and lower gripping arms include pins extending therefrom that are slidably received in the upper and lower guide tracks.

6. The steady rest of claim 5, wherein the working cover plate defines a pair of cavities, each defining an elongated leg and a shorter leg extending therefrom.

7. The steady rest of claim 1, further including an actuation mechanism with a housing having fluid chambers, a piston positioned between the chambers and a ramrod, the housing being secured to the working cover plate and/or the right-hand cover plate.

8. The steady rest of claim 7, wherein the housing and the piston define fluid chambers in communication with upper and lower ports respectively, the ports being in fluid communication with a source of working fluid and a fluid control device that is operable to control a flow of the working fluid in and out of the ports.

9. A method of moving the upper and lower gripping arms of claim 1 from the retracted position to the clamped position, comprising the steps of
injecting a working fluid into a chamber of an actuation mechanism and evacuating at least some working fluid from the chamber, thereby causing a piston to move toward the workpiece, the working fluid from a group consisting of a hydraulic fluid and compressed air;
moving the central plate with the piston along an axis relative to the working plate and the right-hand plate;
as the central plate and gripping arms move toward the clamped position, sliding pins and bushings along legs of corresponding guide tracks so that the bushings come into contact with surfaces of the guide tracks and so that the pins and bushings slide laterally outwardly along lower legs of the guide tracks, protruding ends of the gripping arms thereby moving toward each other to come into contact with and securely clamp the workpiece in cooperation with a gripping finger associated with the central plate, so that a position of the workpiece can be repeatedly controlled with an accuracy of 1 micron.

10. The method of claim 9, further including the step of moving the clamped workpiece horizontally by
rotating a horizontal adjustment rod in a direction that causes movement of the horizontal rail under the influence of a horizontal rail engagement spring, such movement occurring under the constraint of an angle of inclination (theta, 0.92 to 1.08 degrees) between the horizontal rail and a wall of a rail recess so that a wedge effect influences and constrains movement of the guide tracks; and
moving the horizontal rail upwardly under the influence of a rail engagement spring so that a position along the guide tracks at which bushings contact the guide tracks also moves outwardly, thereby displacing the workpiece horizontally, so that a position of the workpiece can be repeatedly and predictably controlled within an accuracy of 1 micron.

11. The method of claim 9, further including the step of moving the clamped workpiece vertically by
rotating a vertical adjustment rod in a direction that causes movement of a vertical rail under the influence of a vertical rail engagement spring, such movement occurring under the constraint of an angle of inclination (theta, 0.92 to 1.08 degrees) between the vertical rail and a wall of a rail recess so that a wedge effect influences and constrains movement of the guide tracks; and
moving the vertical rail upwardly under the influence of the vertical rail engagement spring so that a position along the guide tracks at which bushings contact the guide tracks also moves vertically, thereby displacing the workpiece vertically so that a position of the workpiece can be predictably controlled with an accuracy of 1 micron.

12. A method of using the steady rest of claim 1, comprising a step to replace or repair a worn or failed horizontal or vertical adjustment rod, the step including
slidably detaching the block from the working cover plate;
removing an adjustment rod to be repaired or replaced;
replacing the adjustment rod to be repaired or replaced by threaded engagement with apertures in the block without disassembling the working cover plate from other components of the steady rest; and
reinstalling the block into the working cover plate.

13. The steady rest of claim 1, wherein the angle theta between the two inclined sections of the flat faces of the vertical rail equals the angle that defines the inclination of the flat side and the wall of the horizontal rail.

14. The steady rest of claim 5, wherein the elongated legs of the upper and lower guide tracks each include a flat section to guide the pins linearly and for ease of manufacture and quality control.

15. The steady rest of claim 1, further including a gripping finger that extends from the central plate, the gripping finger cooperating with gripping fingers of the upper and lower gripping arms to grip and finely displace the workpiece when the steady rest is in the clamped position.

16. The method of claim 9, wherein the bushings have a cross-section that is circular.

17. The method of claim 9, wherein the bushings have a cross-section that defines a parallelogram.
